(19) United States
(12) Patent Application Publication
(10) Pub. No.: US 2008/0199057 A1
(43) Pub. Date: Aug. 21, 2008

(54) Portable storage device with fingerprint identification function

(76) Inventors: Hsiang-An Hsieh, Sijhih City (TW); Li-Pai Chen, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/785,604

(22) Filed: Apr. 19, 2007

(30) Foreign Application Priority Data
Feb. 16, 2007 (TW) 96203201

(51) Int. Cl. G06K 9/00

(52) U.S. Cl. 382/125

(57) ABSTRACT

The present invention discloses a portable storage device with a fingerprint identification function. The portable storage device uses a slim sliding fingerprint identifier to detect a user's fingerprint. The slim sliding fingerprint identifier is installed on a lateral side of a housing of the portable storage device such that after the portable storage device is plugged into the application apparatus, the user can enter an identifying fingerprint through the slim sliding fingerprint identifier for a fingerprint identification. The invention enhances the convenience of the fingerprint identification and reduces the circuit occupying area.

### BACKGROUND OF THE INVENTION

1. Field of the Invention

The present invention relates to a portable storage device, and more particularly to a portable storage device with fingerprint identification.

2. Description of Related Art

As science and technology advances, portable storage devices have become an indispensable peripheral used extensively in commercial, educational, and home electronic computing areas. The devices can be conveniently installed to or removed from a computer via an appropriate port such as a USB port or an IEEE1394 port (also known as a firewire port. Therefore, these portable storage devices allow a computer user to transfer data to another unconnected computer.

Since portable storage devices have become increasingly popular in application apparatuses of different mechanisms and personal electronic computing environments, a measure for preventing unauthorized users from accessing information stored in a portable or specific storage medium is one of the important challenges for information technology today. For instance, it is necessary to have a reliable safe detection method to protect confidential data such as commercial, personal, medical, financial and other confidential information. The method must be simple and convenient to use and also provide an appropriate protection standard for the desired information.

At present, some portable storage devices have provided users a high-security biometric identification access control mechanism. Some storage devices (or IC cards) include a fingerprint identification (or biometric identification) as disclosed in R.O.C. Pat. Nos. M249146, I246028 and M298197 provide a fingerprint identifier installed on a front side of the housing of the storage device (or IC card), so that users can enter an identifying fingerprint image from the front side of the housing of the storage device (or IC card).

However, the storage device (or IC card) must be plugged into the application apparatus, and the fingerprint identifier is installed on the front side of the housing of the storage device (or IC card). Thus the fingerprint identifier is covered and blocked by the application apparatus. Users have to enter the fingerprint into a storage device (or IC card) through the fingerprint identifier on the front side of the storage device (or IC card), before plugging the storage device (or IC card) into the application apparatus. Finally, the user's fingerprint image is transmitted to the application apparatus for its identification. In addition, the fingerprint identifier requires a sensor circuit that is quite large to directly detect a user's complete fingerprint.

To achieve the foregoing objective, the storage device (or IC card) requires an additional power source for the fingerprint identifier and uses a sensor circuit with a large size, thus constituting some limitations on the design and the volume of the storage device (or IC card).

In U.S. Pat. No. 6,213,403, a fingerprint identifier can be pulled out of an electronic card for performing fingerprint identifications. While the electronic card is still disposed in the slot of the application apparatus, such technology still cannot overcome the shortcomings of requiring a sensor circuit with a large range of coverage.

Although a slim sliding fingerprint identifier as disclosed in R.O.C. Pat. Nos. I243437 and 200500860 reduces the area occupied by the sensor circuit, the sensing window of the slim sliding fingerprint identifier is still installed to the front side of the storage device (or IC card) in accordance with the aforementioned two patents. Thus these patented technologies still cannot solve the blocking problem when the storage device (or IC card) is plugged into an application apparatus, or the circuit problem produced by the power supply.

### SUMMARY OF THE INVENTION

In view of the foregoing shortcomings, the present invention provides a portable storage device with a fingerprint identification function, which uses a slim sliding fingerprint identifier to detect a user's fingerprint. The slim sliding fingerprint identifier is installed on a lateral side of a housing of the portable storage device, such that after the portable storage device is plugged into an application apparatus, users still can input the desired identifying fingerprint image through the slim sliding fingerprint identifier to identify themselves via their fingerprints. The invention enhances the convenience of executing the fingerprint identification process and reduces the area occupied by the circuit.

The portable storage device with a fingerprint identification function in accordance with the present invention comprises an interface unit, a control unit, a memory unit, and a slim sliding fingerprint identifier, wherein the slim sliding fingerprint identifier is installed on a lateral side of a housing of the portable storage device.

After a user connects the portable storage device to an application apparatus, the slim sliding fingerprint identifier can detect a user's fingerprint to generate a desired identifying fingerprint image. The application apparatus compares the identifying fingerprint image with a pre-registered authorized fingerprint image through a fingerprint identification program and determines whether or not the two images match before the protected file stored in the portable storage device is transmitted to the application apparatus.

In a first preferred embodiment of the present invention, the identifying fingerprint image is produced, and the control unit transmits the fragmented fingerprint images detected by the slim sliding fingerprint identifier to the application apparatus to reconstitute the fragmented fingerprint images into the identifying fingerprint image for further identification.

In a second preferred embodiment of the present invention, the identifying fingerprint image is produced, and the control unit reconstitutes the fragmented fingerprint images detected by the slim sliding fingerprint identifier into the identifying fingerprint image first, and then transmits the identifying fingerprint image to the application apparatus for further identification.

In a first preferred embodiment of the present invention, the identifying fingerprint image is identified, wherein the fingerprint identification program and the authorized fingerprint image are preinstalled in the memory unit.

In a second preferred embodiment of the present invention, the identifying fingerprint image is identified, wherein the fingerprint identification program and the authorized fingerprint image are preinstalled in the application apparatus.

In a third preferred embodiment of the present invention, the identifying fingerprint image is identified, wherein the fingerprint identification program and the authorized fingerprint image are preinstalled in the application apparatus and the memory unit respectively.

To make it easier for our examiner to understand the innovative features and technical content, we use preferred embodiments together with the attached drawings for the detailed description of the invention, but it should be pointed out that the attached drawings are provided for reference and description but not for limiting the present invention.

### BRIEF DESCRIPTION OF THE DRAWINGS

FIG. 1 is a schematic block diagram of a portable storage device with a fingerprint identification function of the present invention;

FIG. 2 is a schematic view of a portable storage device connected to an application apparatus in accordance with the present invention;

FIG. 3 is a schematic view of detecting a user's fingerprint in accordance with the present invention;

FIG. 4 is a perspective view of a portable storage device applied in an electronic card in accordance with the present invention; and

FIG. 5 is a perspective view of a portable storage device applied in a memory card in accordance with the present invention.

### DETAILED DESCRIPTION OF THE PREFERRED EMBODIMENTS

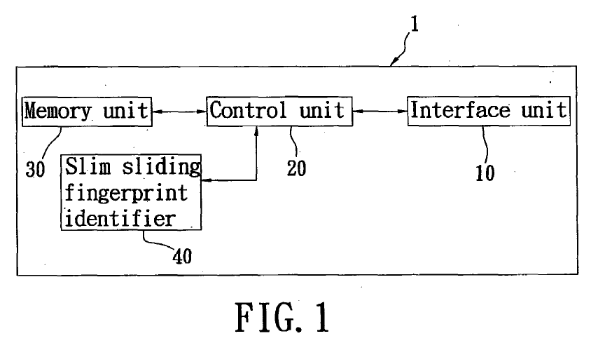

Referring to FIG. 1, a portable storage device with a fingerprint identification function in accordance with the present invention is shown. The portable storage device comprises an interface unit 10, a control unit 20, a memory unit 30, and a slim sliding fingerprint identifier 40.

The slim sliding fingerprint identifier 40 is installed on a lateral side of the portable storage device 1 to facilitate the convenient detection a user's fingerprint via the slim sliding fingerprint identifier 40. The portable storage device 1 also has a sensing window on a lateral side of its housing, such that the slim sliding fingerprint identifier 40 can detect the user's fingerprint. In addition, the slim sliding fingerprint identifier 40 detects the fingerprint through the sensing window, and thus a fragmented fingerprint image is obtained each time, and several fragmented fingerprint images are detected and reconstituted into a complete identifying fingerprint image.

The control unit 20 is connected to the slim sliding fingerprint identifier 40 for controlling the internal operation of the portable storage device 1. In a preferred embodiment of the present invention, the control unit 20 sends out the detected fragmented fingerprint images for the reconstitution of a complete identifying fingerprint image if the slim sliding fingerprint identifier 40 detects the fragmented fingerprint image. In another preferred embodiment of the present invention, the control unit 20 reconstitutes the fragmented fingerprint images into a complete identifying fingerprint image first before sending out the identifying fingerprint image if the slim sliding fingerprint identifier 40 detects the fragmented fingerprint images.

The interface unit 10 is connected to an application apparatus (not shown in the figure). If the portable storage device 1 is connected to the application apparatus, data can be exchanged between the interface unit 10 and the application apparatus. Thus the interface unit 10 can be a universal serial bus (USB) interface, an express card interface, or a general PCI interface (not shown in the figure), and can even include a universal serial bus (USB) interface (not shown in the figure) and an express card interface (not shown in the figure) concurrently.

If the interface unit 10 includes a universal serial bus (USB) interface (hereinafter referred to as a USB interface) and an express card interface concurrently, the voltage supplied by the express card interface is different from the voltage supplied by the USB interface since the express card interface and the USB interface come with different specifications for the voltage requirement. In this embodiment, the aforementioned voltage issue of the portable storage device 1 can be solved by a power management unit (not shown in the figure) and a separation unit (not shown in the figure). The power management unit modulates the voltage supplied by the USB interface or the express card interface to meet the operating requirements of the portable storage device. The application apparatus can select the portable storage device connected with the express card interface or the USB interface.

The memory unit 30 is connected to the control unit 20 for storing a protected file. However, the operating voltages of the interface unit 10, the control unit 20, and the memory unit 30 are all different when data transmission takes place between the memory unit 30 and the application system. Thus the aforementioned power management unit can be used for modulating and supplying the required operating voltage for the memory unit 30. In addition, the power management unit can modulate the operating voltage of the memory unit 30 according to identification data such as a model number, a specification, and a brand of the memory unit.

In a second preferred embodiment of the memory unit 30, the memory unit 30 further stores an authorized fingerprint image or its characteristic values. The authorized fingerprint image or its characteristic values are preinstalled in the memory unit 30. They are the fingerprint image or the characteristic values of an authorized user which are then compared with the identifying fingerprint image or the characteristic values of the identifying fingerprint image. In a third preferred embodiment of the memory unit 30 the memory unit 30 further stores an authorized fingerprint image or its characteristic values and a fingerprint identification program. The memory unit 30 can be a flash memory.

In the description above the portable storage device 1 of the present invention is installed in an application apparatus such as a computer, a personal digital assistant (PDA), or a cell phone.

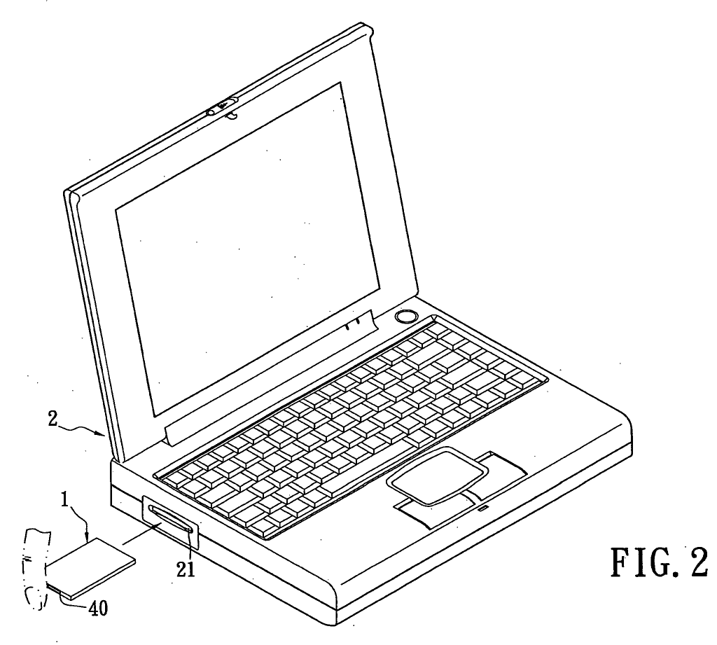

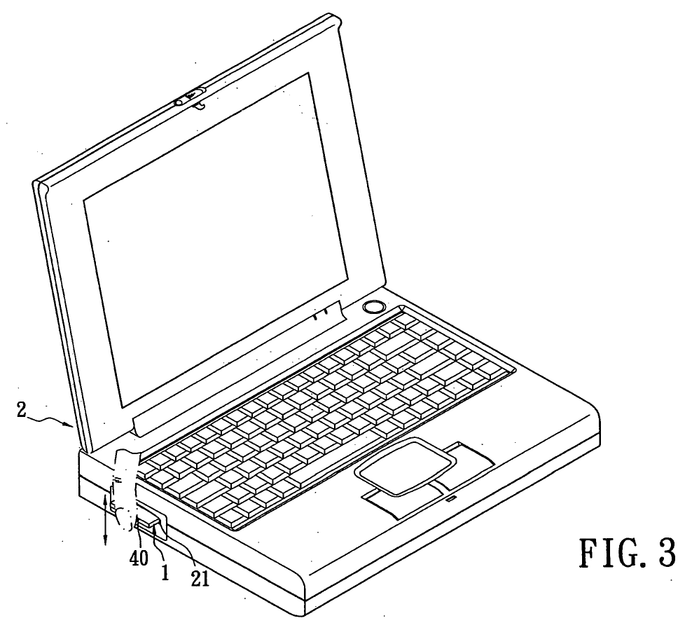

Please refer to FIGS. 2 and 3 for the operations of capturing a user's fingerprint and identifying the fingerprint when the portable storage device 1 is connected to an application apparatus in accordance with the present invention. FIG. 2 shows a schematic view of a portable storage device 1 connected to an application apparatus in accordance with the present invention. FIG. 3 shows a schematic view of a portable storage device 1 detecting a user's fingerprint in accordance with the present invention.

A sensing window corresponding to a lateral side of an interface unit 10 is disposed on the housing of the portable storage device 1 provided for the slim sliding fingerprint identifier 40 for detecting fragmented fingerprint images. The portable storage device 1 is plugged into a slot 21 on a lateral side of an application apparatus 2 and provided for exposing the application apparatus 2 from the sensing window for the slim sliding fingerprint identifier 40 to detect fragmented fingerprint images.

A user's finger must be placed either near the sensing window or make contact with the sensing window so that the slim sliding fingerprint identifier 40 can detect the user's fingerprint. If the slim sliding fingerprint identifier 40 presets its scanning of fingerprints in a direction perpendicular to the extending direction of the sensing window, then users will have to move their fingers vertically up and down such that the slim sliding fingerprint identifier 40 can detect a complete fingerprint. If the slim sliding fingerprint identifier 40 presets its scanning of fingerprints in a direction parallel to the extending direction of the sensing window, then users will have to move their fingers sideways, such that the slim sliding fingerprint identifier 40 can detect a complete fingerprint. The scanning of fingerprints in accordance with the preferred embodiment of the present invention may include the direction of scanning fingerprints as disclosed in R.O.C. Pat. No. 200500860.

Alternatively, the application apparatus 2 pre-installs a fingerprint identification program and an authorized fingerprint image for the fingerprint identification in accordance with a first preferred embodiment of the present invention. If the portable storage device 1 is connected to the application apparatus 2, the application apparatus 2 will request users to enter the identifying fingerprint image through the portable storage device 1.

If the slim sliding fingerprint identifier 40 detects a user's fragmented fingerprint images, the fragmented fingerprint images will be firstly sent to the control unit 20 for processing, and then sent to the application apparatus 2 through the interface unit 10 for the reconstituting process. The application apparatus 2 further receives several fragmented fingerprint images through the fingerprint identification program and reconstitutes the fragmented fingerprint images into a complete identifying fingerprint image. The application apparatus 2 then compares whether or not the identifying fingerprint image matches the pre-stored authorized fingerprint image.

If the identifying fingerprint image matches the pre-stored authorized fingerprint image, the portable storage device 1 permits the protected file stored in the memory unit 30 to be sent to the application apparatus 2 through the interface unit 10. If the identifying fingerprint image does not match the pre-stored authorized fingerprint image, the portable storage device 1 will prohibit the protected file stored in the memory unit 30 from being sent to the application apparatus 2 through the interface unit 10.

The difference between the execution of a fingerprint identification process in accordance with a second preferred embodiment of the present invention from that of the first preferred embodiment resides in that the fingerprint identification program and the authorized fingerprint image are preinstalled in a memory unit 30. If the portable storage device 1 is connected to the application apparatus 2, the application apparatus 2 will request a user to enter the identifying fingerprint image through the portable storage device 1, and the memory unit 30 will retrieve the fingerprint identification program and the authorized fingerprint image.

The difference between the execution of a fingerprint identification process in accordance with a third preferred embodiment of the present invention from that of the first and second preferred embodiments resides in that the memory unit 30 only stores either the fingerprint identification program or the authorized fingerprint image, and the application apparatus 2 stores the other, such that if the portable storage device 1 is connected to the application apparatus 2, the application apparatus 2 will request a user to enter the identifying fingerprint image through the portable storage device 1 and the memory unit 30 will retrieve the fingerprint identification program or the authorized fingerprint image.

If the memory unit 30 pre-stores the authorized fingerprint image, and the application apparatus 2 pre-stores the fingerprint identification program, then the application apparatus 2 will retrieve the authorized fingerprint image from the memory unit 30 and use the fingerprint identification program to identify whether or not the authorized fingerprint image matches the received identifying fingerprint image.

In the execution of fingerprint identification in accordance with the first, second and third preferred embodiments of the present invention, several fragmented fingerprint images detected by the slim sliding fingerprint identifier 40 can be reconstituted into the identifying fingerprint image in the control unit 20 first, and then sent out through the interface unit 10 for the fingerprint identification process. During the fingerprint identification process, the characteristic values of the authorized fingerprint image are used for determining whether or not the identifying fingerprint image (or its characteristic values) match.

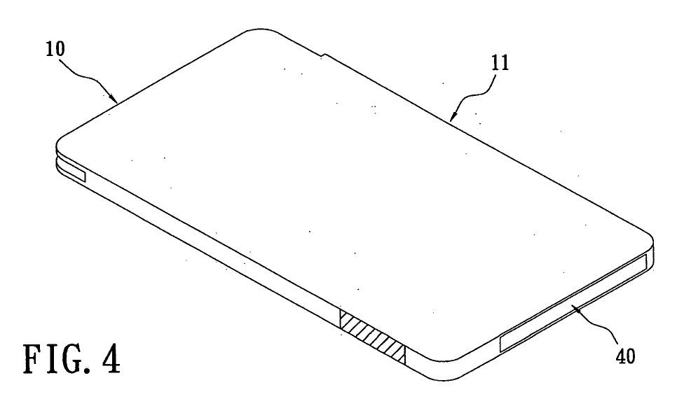

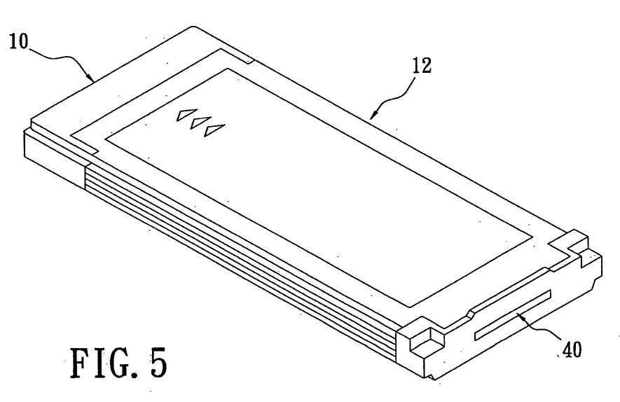

After the portable storage device 1 of the present invention is plugged into the application apparatus 2, a fingerprint image can still be scanned, and thus the invention provides different application modes applied in an electronic card (or a main body) 11 as shown in FIG. 4, or a memory card 12 as shown in FIG. 5. The memory card (or main body) 12 comes with an express card interface.

In summation of the description above, the present invention features the following advantages as described below. If the portable storage device is plugged into the slot of the application apparatus, a user can still use the slim sliding fingerprint identifier to identify his or herself, and further transmit a protected file stored in the portable storage device to the application apparatus.

Different interfaces can be used in the interface unit of the portable storage device for different application apparatuses.

The electrical power required for the operation of the slim sliding fingerprint identifier in the portable storage device can be supplied by the application apparatus.

The fingerprint identification program and the authorized fingerprint image (or its characteristic values) required for identifying fingerprints can be preinstalled in the application apparatus.

The fingerprint identification program and the authorized fingerprint image (or its characteristic values) required for identifying fingerprints can be preinstalled in the portable storage device.

The fingerprint identification program and the authorized fingerprint image (or its characteristic values) required for identifying fingerprints can be preinstalled in the application apparatus and the portable storage device respectively.

Several fragmented fingerprint images detected by the slim sliding fingerprint identifier are sent to the application apparatus first, and then reconstituted into the identifying fingerprint image.

Several fragmented fingerprint images detected by the slim sliding fingerprint identifier are reconstituted into identifying fingerprint image in the portable storage device, and the identifying fingerprint image is sent to the application apparatus for the identification.

Although the present invention has been described with reference to the preferred embodiments thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A portable storage device with a fingerprint identification function, comprising:
a slim sliding fingerprint identifier, installed on a lateral side of the portable storage device, for detecting a fingerprint that is slid through the slim sliding fingerprint identifier to produce an identifying fingerprint image;
a control unit, coupled to the slim sliding fingerprint identifier, for controlling the operation of the portable storage device;
an interface unit, for connecting the control unit to an external application apparatus of the portable storage device; and
a memory unit, coupled to the control unit, for storing a protected file.

2. The portable storage device with a fingerprint identification function of claim 1, wherein the interface unit is a universal serial bus (USB).

3. The portable storage device with a fingerprint identification function of claim 1, wherein the interface unit is an express card interface.

4. The portable storage device with a fingerprint identification function of claim 1, wherein the interface unit is a PCI interface.

5. The portable storage device with a fingerprint identification function of claim 1, wherein the interface unit comprises a universal serial bus (USB) and an express card interface.

6. The portable storage device with a fingerprint identification function of claim 1, wherein the application apparatus is a computer, a personal digital assistant (PDA), or a cell phone.

7. The portable storage device with a fingerprint identification function of claim 1, wherein the fingerprint is slid in a direction perpendicular to or parallel to an extending direction of a sensing window of the slim sliding fingerprint identifier.

8. The portable storage device with a fingerprint identification function of claim 1, wherein the control unit transmits a plurality of fragmented fingerprint images detected by the slim sliding fingerprint identifier to the application apparatus through the interface unit, for reconstituting the plurality of fragmented fingerprint images into the identifying fingerprint image.

9. The portable storage device with a fingerprint identification function of claim 1, wherein the control unit reconstitutes a plurality of fragmented fingerprint images detected by the slim sliding fingerprint identifier into the identifying fingerprint image, and transmits the identifying fingerprint image to the application apparatus through the interface unit.

10. The portable storage device with a fingerprint identification function of claim 1, wherein the memory unit further stores an authorized fingerprint image, so that the application apparatus can identify whether or not the identifying fingerprint image matches the authorized fingerprint image by retrieving the authorized fingerprint image.

11. The portable storage device with a fingerprint identification function of claim 10, wherein the memory unit further stores a fingerprint identification program, so that the application apparatus can reconstitute a plurality of fragmented fingerprint images detected by the slim sliding fingerprint identifier into the identifying fingerprint image through the fingerprint identification program, and identifies whether or not the identifying fingerprint image matches the authorized fingerprint image.

12. The portable storage device with a fingerprint identification function of claim 1, wherein the memory unit further stores characteristic values of an authorized fingerprint image, so that the application apparatus can identify whether or not characteristic values of the identifying fingerprint image match the characteristic values of the authorized fingerprint image by retrieving the characteristic values of the authorized fingerprint image.

13. The portable storage device with a fingerprint identification function of claim 12, wherein the memory unit further stores a fingerprint identification program, so that the application apparatus can reconstitute a plurality of fragmented fingerprint images detected by the slim sliding fingerprint identifier into the identifying fingerprint image to produce characteristic values through the fingerprint identification program and identify whether or not the characteristic values of the identifying fingerprint image match the characteristic values of the authorized fingerprint image.

14. The portable storage device with a fingerprint identification function of claim 1, wherein the application apparatus pre-stores an authorized fingerprint image or characteristic values of the authorized fingerprint image and a fingerprint identification program, and reconstitutes a plurality of fragmented fingerprint images detected by the slim sliding fingerprint identifier into the identifying fingerprint image or characteristic values of the identifying fingerprint image through the fingerprint identification program, and identifies whether or not the identifying fingerprint image matches the authorized fingerprint image or the characteristic values of the identifying fingerprint image match the characteristic values of the authorized fingerprint image.

15. A portable storage device with a fingerprint identification function, comprising:
a main body, having a first end and a second end, and a memory unit and a control unit installed in the main body, and the first end opposed to the second end;
an interface unit, installed on the first end; and
a slim sliding fingerprint identifier, installed on the second end.

16. The portable storage device with a fingerprint identification function of claim 15, wherein the interface unit is a universal serial bus (USB).

17. The portable storage device with a fingerprint identification function of claim 15, wherein the interface unit is an express card interface.

18. The portable storage device with a fingerprint identification function of claim 15, wherein the interface unit is a PCI interface.

19. The portable storage device with a fingerprint identification function of claim 15, wherein the interface unit includes a universal serial bus (USB) and an express card interface.

20. The portable storage device with a fingerprint identification function of claim 15, wherein the fingerprint is slid in a direction perpendicular to or parallel to an extending direction of a sensing window of the slim sliding fingerprint identifier.
